(19) United States
(12) Patent Application Publication
(10) Pub. No.: US 2003/0105657 A1
(43) Pub. Date: Jun. 5, 2003

(54) Personal resource management tool

(76) Inventors: Murali K. Nandigama, San Jose, CA (US); Uday S. Dhanikonda, San Jose, CA (US); Philip A. Chin, San Jose, CA (US)

Correspondence Address: MARTINE & PENILLA, LLP, 710 LAKEWAY DRIVE, SUITE 170, SUNNYVALE, CA, 94085, US

(21) Appl. No.: 09/990,789

(22) Filed: Nov. 16, 2001

(51) Int. Cl. G06F 17/60

(52) U.S. Cl. 705/9

(57) ABSTRACT

Methods and a system for tracking project progress and dynamically readjusting the project progress when interruptions to the project are received are provided. One exemplary method tracks task progression for each member in a group. The method initiates with recording projects of the group. Then, project tasks for each member in the group are planned, where the tasks are directed towards completing the projects. Next, a request for an ad hoc task which interrupts a schedule for the planned project tasks is received. Then, the project tasks are readjusted to capture the interruption of the ad hoc task. Next, a report for each member in the group is requested. The report is configured to display progress of the project tasks for each member. Additionally, the report is capable of presenting the ad hoc tasks for each member of the group over a tracking period.

### BACKGROUND OF THE INVENTION

1. Field of the Invention

This invention relates generally to methods for managing resources and more particularly for providing a tool to assist managers in understanding employee task loads and centralizing a repository of initiatives of a group in a unified format in order to monitor resource utilization.

2. Description of the Related Art

Objective assessment of an employee capabilities is always a challenging task for a manager. It is all too common where a manager's perception of the employee and the employees perception of his or her own capabilities are often divergent. In addition, recent impressions tend to weigh heavily on a manager's opinion of an employee. As a result of mismatched perceptions and too much emphasis on recent impressions, the employer may lose the employee, which in turn causes economic inefficiencies for the organization.

In addition, a typical assessment model in many companies takes on the form of forced rankings being applied to fit a Gaussian curve i.e., a bell curve. While this model is accurate for a large samples, it is commonly applied to small groups such as 30 employees or less. However, small groups do not fit strictly into a Gaussian curve distribution. Thus, even if a manager is not influenced by recent impressions, he may be forced into assessing an employee in a manner dictated to fit the Gaussian curve distribution. More importantly, if a manager does not possess the proper data prior to using the Gaussian model, mistakes or misperceptions are exacerbated by the limitations of the model.

During restructuring events, managers are usually confronted with decisions centering around retaining employees and outsourcing resources. Here again a manager often does not have a complete objective picture of his subordinates. For example the employee may be assisting other managers in ways not known by the employee's manager. As such, the employee's manager may assume the employee is not performing his job duties when in actuality he is being utilized for ad hoc requests from other managers. In such a situation, the manager's negative perception may dominate in his assessment of the employee even though it is not accurate. From a resource management point of view, a manager does not have a centralized repository where he can objectively evaluate the employee's past performance as well as obtain an understanding of the employees current workload.

Calendars for personal computers are currently used by employees to manage time. However, it can not be ascertained whether the tasks were completed in a timely fashion i.e., whether the employee completed the task efficiently. In addition, calendars limit the access of who can view the calendar or what information can be viewed. More importantly, many work environments are structured where teams or groups work on projects and multiple teams or groups may be interacting on a single project or task. Therefore, the limited access and proprietary nature of software to be used, which requires each user to have a local copy, restricts the utility of advanced calendars.

Beyond the scheduled work listed in calendars or applications such as MICROSOFT PROJECT,™ unscheduled work, which may interrupt the scheduled work, can not be quantified or tracked. That is, the prior art techniques do not provide for any dynamic readjustment to incorporate unscheduled interruptions. In any work environment there are constantly unforeseen issues which need to be resolved and these unforeseen issues may or may not be related to a scheduled project. While weekly reports from a manager may capture some of the unscheduled work, the reports are time consuming and the manager must consolidate the information from a plethora of sources since it is not centralized, not to mention the obstacles involved with the multiple communication layers.

As a result, there is a need to solve the problems of the prior art to provide a tool to assist managers in evaluating employees as well as tracking unscheduled work which interrupts scheduled projects.

### SUMMARY OF THE INVENTION

Broadly speaking, the present invention fills these needs by providing a method and system for tracking planned tasks and dynamically readjusting the planned tasks in the event of a non-planned task interrupts the progression of the planned tasks. It should be appreciated that the present invention can be implemented in numerous ways, including as a process, a system, or a device. Several inventive embodiments of the present invention are described below.

In one embodiment, a method for tracking task progression for each member in a group is provided. The method initiates with recording projects of the group. Then, project tasks for each member in the group are planned. The project tasks are directed towards completing the projects. Next, a request is received for an ad hoc task which interrupts a schedule for the planned project tasks. Then, the project tasks are readjusted to capture the interruption of the ad hoc task. Next, a report for each member in the group is requested. The report is configured to display progress of the project tasks for each member. In addition, the report is capable of presenting the ad hoc tasks for each member of the group over a tracking period.

In another embodiment, a computer implemented method for coordinating projects is provided. The projects include tasks to be performed to complete the projects. The method initiates with establishing a projected project list tallying the projects. Then, each of the projects of the projected project list is divided into planned tasks. Next, the planned tasks are assigned. Then, a request for an ad hoc task which interrupts a planned task schedule is received. Next, the ad hoc task is stored. Then, in response to receiving the ad hoc task, the method further includes, readjusting the planned task schedule to incorporate the interruption caused by the ad hoc task.

In yet another embodiment, a computer readable media having program instructions for tracking task progression for each member in a group is provided. The computer readable media includes program instructions for recording projects of the group. Program instructions for planning project tasks for each member in the group are also included. The tasks are directed towards completing the projects. Program instructions for receiving a request for an ad hoc task which interrupts a schedule for the planned project task is included. The computer readable media includes program instructions for readjusting the project tasks to capture the interruption of the ad hoc task. Program instructions for requesting a report for each member in the group is included. The report is configured to display progress of the project tasks for each member. In addition, the report is capable of presenting the ad hoc tasks for each member of the group over a tracking period.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 illustrates flowchart 100 displaying an overview of the set-up method to identify and assign projects and tasks to groups in accordance with one embodiment of the invention.

FIG. 2A provides an exemplary illustration of a projected project list in accordance with one embodiment of the invention.

FIG. 2B represents an exemplary diagram of the approved projects of FIG. 2A assigned to groups, in addition to representing the tasks being assigned to individual members of the groups in accordance with one embodiment of the invention.

FIG. 3 illustrates flowchart 140 displaying a method for acquiring the data for the planned projects and ad hoc projects in accordance with one embodiment of the invention.

FIG. 4 illustrates a diagram of the various databases used for the personnel resource management tool in accordance with one embodiment of the invention.

FIG. 5 illustrates flowchart 166 displaying a method for mining the data in various databases for presentation in accordance with one embodiment of the invention.

### DETAILED DESCRIPTION OF THE PREFERRED EMBODIMENTS

An invention is described for a tool to assist in the management of resources which is capable of dynamically re-adjusting a task list to capture unscheduled events and at the same time is easily accessible. It will be obvious, however, to one skilled in the art, that the present invention may be practiced without some or all of these specific details. In other instances, well known process operations have not been described in detail in order not to unnecessarily obscure the present invention.

The embodiments of the present invention provide a tool for assisting a manager in the assessment of an employee. In one embodiment, the tool centralizes the project list in a manner where the pre-planning of the project is combined with the ability to dynamically modify the tasks of the project during execution of the project. The tool can be accessed through a distributed network, such as the Internet, through a web browser. In addition, various security levels are incorporated, thus allowing certain personnel access to higher level features in another embodiment of the invention. A central repository of ideas, also referred to as a projected project list, is maintained by the personnel responsible for implementing each of the ideas or projects.

Table 1 illustrates an exemplary list of the planned projects in accordance with one embodiment of the invention. While Table 1 exhibits the projected project list (PPL) for members M1-M3 of one group, the project list can be geared toward multiple groups of an organization. In one embodiment, members of any group may submit projects to the PPL, where they reside until approved by the organization, thereby empowering employees and encouraging employee participation. Table 1 includes a brief description of the project and a link to a detailed description. For example, the “click here” text represents a link to another document in one embodiment. Additionally, the start date and approximate end date are parameters also capable of being viewed. Under the completion percentage column, the top number indicates the percent of completion of the project. By clicking on the “change” text a drop down menu is displayed allowing a user to change the top number to update the percentage completion in one embodiment. In another embodiment, the ability to change or add information to the PPL is controlled through access levels. For example, a manager is given access to make certain entries, while a group member is provided further restricted access to make changes.

In addition to the PPL, separate tasks for completing each project are identified. In one embodiment these planned tasks are entered by the group member with responsibility for completing the task. In another embodiment, planned tasks, which reflect sub-components requiring action in order to complete a project, are entered at the beginning of a tracking period. The tracking period can be any defined amount of time, such as a day, week, month, etc. Where the tracking period is one week the planned tasks for the week are entered at the beginning of the week. Then, at the end of each week, the completed tasks are input by the appropriate personnel. Unplanned or ad hoc tasks, which interrupt the planned tasks are also input in another embodiment of the invention.

TABLE 1

| Name of | | Detailed | | Approximate | Completion |
|---|---|---|---|---|---|
| Initiator | Project description | description | Start Date | End Date | Percentage |
| M1 and M2 | Personnel Resource | Click here | 03-20-2001 | 03-25-2001 | 80 |
| | Management: PRM | | | | — |
| | tool helps to track | | | | 10% |
| | the tasks | | | | Change |
| | commitment and | | | | |
| | completion status | | | | |
| | for each employee | | | | |
| | and can generate a | | | | |
| | report for the same | | | | |
| | for the given period. | | | | |
| M1 and M3 | Project X Webpage | Click here | 05-04-2001 | 05-24-2001 | 100 |
| | creation | | | | — |
| | | | | | 10% |
| | | | | | Change |
| M1 | To Profile | Click here | 08-06-2001 | 08-30-2001 | 20 |
| | component X to | | | | — |
| | generate tasks. This | | | | 10% |
| | helps to pinpoint to | | | | Change |
| | areas which need | | | | |
| | development. | | | | |
| M1 | Code Management | Click here | not available | not available | 0 |
| | Tool | | yet | yet | — |
| | | | | | 10% |
| | | | | | Change |

It should be appreciated that the above mentioned inputs of the projects i.e., planned tasks and ad-hoc tasks are stored in a database or separate databases. In one embodiment of the invention, the data stored in the databases is presented in a format allowing a manager or employee to review his performance objectively. For example, the tasks can be viewed in a table of completed tasks versus planned tasks for an individual or for a group. Here, the manager has an objective view of the work being performed and completed by members of the group in a single report. Additionally, the manager is able to determine if an employee was unable to complete planned tasks due to requests from other managers for unplanned tasks or other unforeseen events. The manager has the option to view the ad hoc tasks and identify the requester of the ad hoc tasks in another embodiment.

Table 2 illustrates an exemplary printout of the tasks completed versus the tasks committed to for employee X over a period of time in accordance with one embodiment of the invention. While Table 2 illustrates data presented over a weekly timeframe, any timeframe may be used. Table 2 illustrates planned tasks from the beginning of the timeframe and completed tasks at the end of the timeframe. In one embodiment, the planned tasks are pulled from a planned task database while the completed tasks are pulled from a completed task database. The pulled data is then combined to create a report such as the report illustrated in Table 2.

TABLE 2
Employee X
Tasks Completed vs. Tasks Committed

| | BEGINNING OF TIME PERIOD | |
|---|---|---|
| Time Period | SCHEDULE | END OF TIME PERIOD STATUS |
| 1 | Complete testing for wizard-beta on platform 1 | Completed testing for wizard-beta on |
| | and platform 2 | platform 1; Still trying to resolve the |
| | Help for wizard testing | problems on platform 2 |
| | Sort for licenses for the lab | Started Wizard mile-stone tests |
| | Update documents | |
| 2 | Reliability black-box testing. | Completed the testing on platform 2. |
| | Complete license sorting | Finished mile-stone testing for wizard |
| | Update documents | Started work on reliability black-box |
| | Further work on having simplified script for | testing |
| | bug-tagging | |
| | Wizard testing support | |
| 3 | Complete half of the work on reliability black-box | Completed the evaluation for reliability |
| | testing engine | black-box testing |
| | Wizard week-ahead testing on one platform | Requested all for sending licenses |
| | Wizard build testing on Solar | |
| | Code coverage execution | |
| | Help on unified testbase whenever required. | |
| 4 | Further work on reliability test-engine | Wizard week-ahead testing on one platform |
| | Help on unified testbase when needed | Completed half work on reliability test- |
| | Week-ahead testing on platform 2 | engine |
| | Further work on vm regression script and | |
| | conversions | |
| | Code coverage execution | |
| 5 | Further work on reliability test-engine | Further work on reliability test-engine |
| | cl-support - preparation of runLists for | cl-support - preparation of runLists for |
| | different testbases | different testbases |
| | Further work on regression script and conversions | |
| | Week-ahead testing on platforms and filing of | |
| | bugs | |
| 6 | Complete sorting licenses for the lab. | Ran reflection tests on X's build in all three |
| | Test Monday build for 1.5 days | modes on all 5 platforms. |
| | Run reflection tests on X's build on all platforms | |
| | Further work on reliability tests | |
| 7 | Complete sorting licenses for the lab. | Full testing for X on Platform 3 |
| | Complete work on reliability tests for VM | Modified tool to generate format report |
| | cl-support | |
| | Further work on vm regression script and | |
| | conversions | |
| | Change tool to generate format report | |

Table 3 illustrates a list of ad hoc tasks sorted by the groups responsible for generating the ad hoc request. From Table 3 a manager can learn which requesters and which groups are responsible for taking an employee away from planned tasks. In one embodiment, the ad hoc tasks are pulled from an ad hoc task database and presented as illustrated in Table 3. In another embodiment, the group member requested to perform the ad hoc task enters the pertinent information into the ad hoc task database. Tables 1, 2, and 3 are shown for illustrative purposes only and are not meant to be limiting as any number of reports in various formats can be generated from the data input into the database or databases.

TABLE 3

| | Name of | Task | Start | Committed | Assigned |
|---|---|---|---|---|---|
| | Requester | description | Date | End Date | to |
| Group 1 | R1 | misc testing. | 04/05/XX | | M1. |
| | R2 | Test security | 04/09/XX | 04/10/XX | M1, M2. |
| | | test fix | | | |
| Group 2 | R3 | Test CTW | 04/06/XX | 04/06/XX | M3, M4. |
| | | test. | | | |
| | R4 | verify _beta | 04/27/XX | 05/01/XX | M3. |
| | | putback on | | | |
| | | V8 machine. | | | |
| | R4 | Verify some | 05/02/XX | 05/03/XX | M3. |
| | | timeout in | | | |
| | | DTF. | | | |
| | R5 | verifying | 07/30/XX | 08/01/XX | M2. |
| | | slowness. | | | |
| Group 3 | R6 | Run FULL | 04/11/XX | 04/12/XX | M1. |
| | | test using | | | |
| | | runthese. | | | |
| | R7 | Putback | 08/01/XX | 08/02/XX | M3. |
| | | testing. | | | |
| Group 4 | R8 | Project | 04/04/XX | 04/05/XX | M2. |
| | | Testing. | | | |
| | R9 | Test 1 for | 04/06/XX | 04/06/XX | M2, M4. |
| | | R1's jdbx. | | | |
| | R10 | Misc/gc for | 04/05/XX | 04/06/XX | M3. |
| | | R1's jdbx. | | | |
| | R10 | verifying | 04/24/XX | 04/24/XX | M5. |
| | | bug status. | | | |

In one embodiment, the databases are continually updated by the personnel responsible for entering the data. Of course, the manager or another individual interested in viewing the data can choose any timeframe to view reports generated from the databases. Additionally, filters may be employed to limit the reports to certain group members, time frames, tasks, etc. Security levels are set to allow access to levels of features and the ability to modify entered data in one embodiment. While the embodiments below may make reference to a software development environment, it should be appreciated that the tool is applicable to any project oriented environment where projects are initiated and employees are evaluated, at least partially, in terms of the progress of the initiated projects.

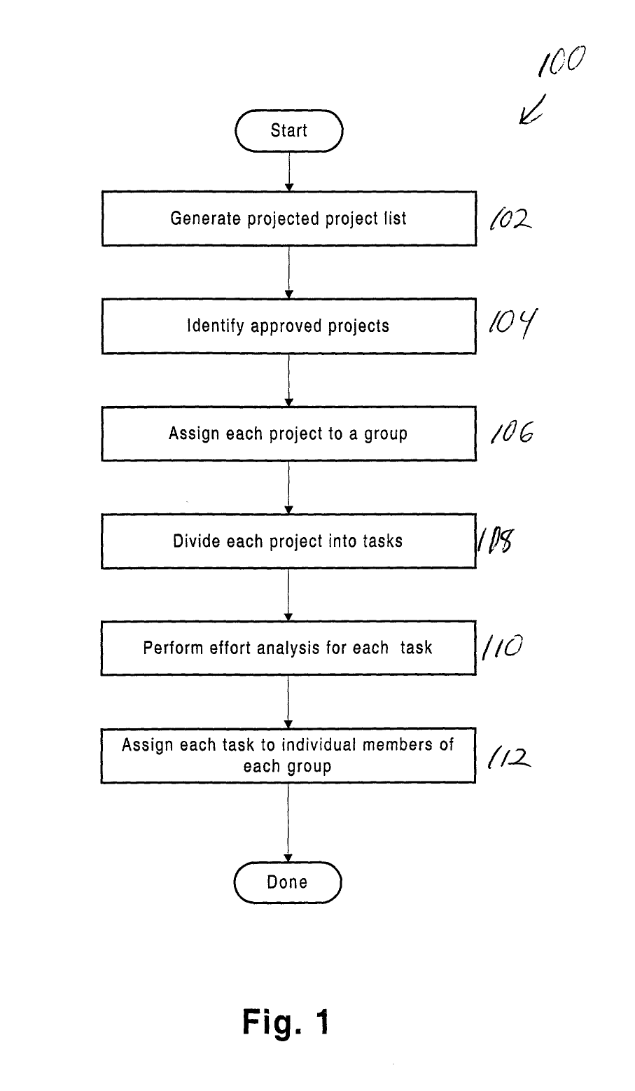

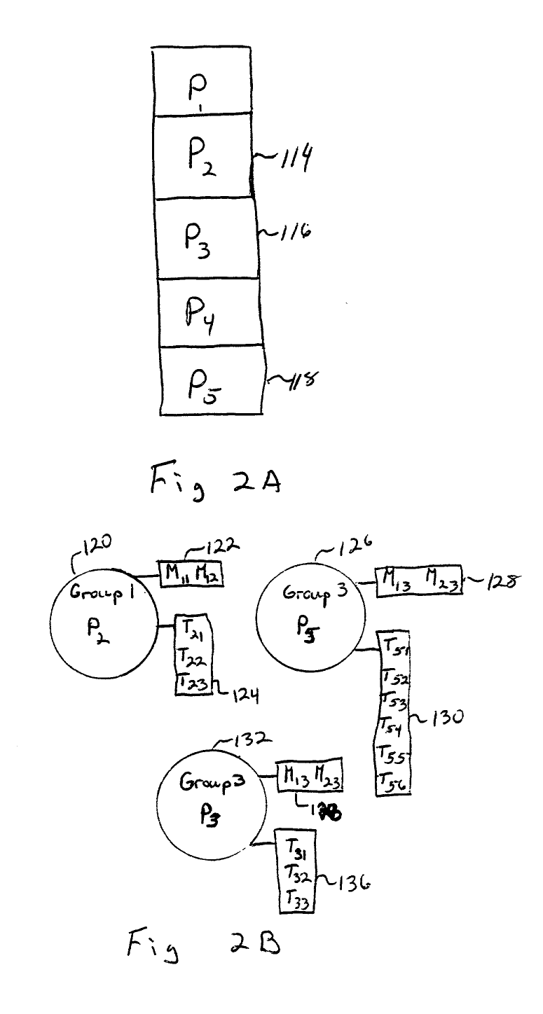

FIG. 1 illustrates flowchart 100 displaying an overview of the set-up method to identify and assign projects and tasks to groups in accordance with one embodiment of the invention. Flowchart 100 initiates with operation 102 where a projected project list (PPL) is generated. In one embodiment the PPL is contained in a database as a flat file. Next, approved projects from the PPL are identified. FIG. 2A provides an exemplary illustration of a projected project list in accordance with one embodiment of the invention. As illustrated in FIG. 2A, the project list includes projects P₁-P₅. Projects P₂ 114, P₃ 116 and P₅ 118 are considered approved for the purposes of the examples provided herein. It should be appreciated that FIG. 2A is provided only for illustrative purposes and is not meant to be limiting in any way. Additionally, Table 1 provides a more detailed illustration of a PPL.

Returning to FIG. 1, the method then advances to operation 106 where each project is assigned to a group. For example, in a software environment one or more of the approved projects are assigned to a testing group while one or more of the remaining approved projects are assigned to an Internet group and so on. Then, in operation 108 each approved project is divided into tasks. Here, as with any project, the entire project can be broken down into tasks which may or may not be performed by the group assigned to the overall project as will be explained in reference to operation 112. Moving to operation 110, an effort analysis for each task is performed. In one embodiment, the effort analysis determines an amount of time to budget for each task so that a matrix for each project can be mapped out. Next, in operation 112 each task is assigned to individual members of each group. In one embodiment, the individual members can be a member of the group assigned to the overall project in operation 106. Alternatively, the individual members can be members of a group not assigned to the overall project since some tasks require the expertise of outside groups. Upon the completion of flowchart 100, a PPL database and a planned task database contain the pertinent data for each project and each task associated with each project.

FIG. 2B represents an exemplary diagram of the approved projects of FIG. 2A assigned to groups, in addition to representing the tasks being assigned to individual members of the groups in accordance with one embodiment of the invention. FIG. 2B displays project P₂ assigned to group 1 120, project P₅ assigned to group 3 126 and project P₃ also assigned to group 3. Members M₁₁ and M₁₂ 122 are the members of group 1, while the group 3 members are M₁₃ and M₂₃ 128. The tasks associated with project P₂ are listed in task box 124. The tasks for project P₅ and for project P₃ are listed in task boxes 130 and 136, respectively. It should be appreciated that the members of each group are not limited to being assigned tasks associated only with projects which the member's group has responsibility. For example, members M₁₃ and M₂₃ can be assigned tasks associated with project P₅ as well as tasks associated with project P₂. More specifically, task T₂₃ of task box 124 may be assigned to M₁₃ in one embodiment, especially if the task T₂₃ requires the expertise of member M₁₃.

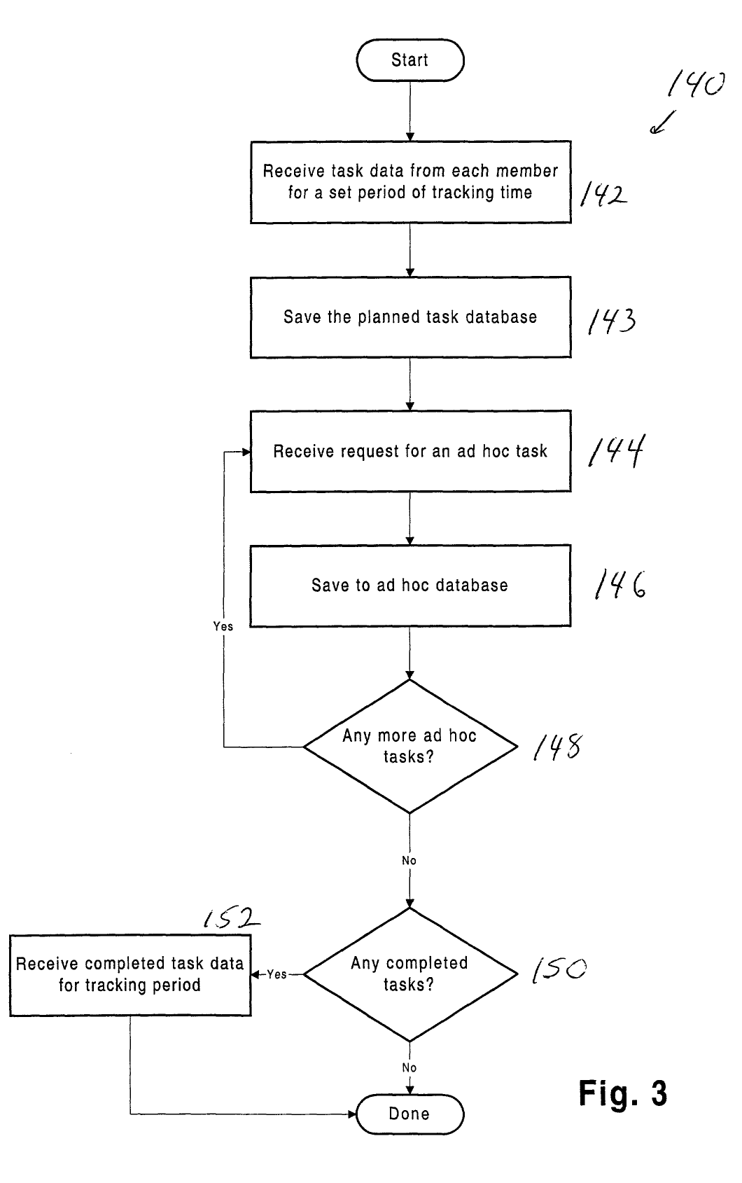

FIG. 3 illustrates flowchart 140 displaying a method for acquiring the data for the planned projects and ad hoc projects in accordance with one embodiment of the invention. Flowchart 140 initiates with operation 142 where task data from each member is received for a set period of tracking time. In one embodiment, each member is responsible for inputting the task data where they are the responsible party. The tracking period can be any period of time such as a number of days, weeks, months, etc. Next, the method proceeds to operation 143 where the task data from operation 142 is saved to a planned task database. In one embodiment, the planned task database is a flat file. The method then advances to operation 144 where a request for an ad hoc task is received. As used herein, an unplanned task and an ad hoc task are the same. Referring back to FIG. 2B, the manager of group 1 may ask member M₁₃ of group 3 to perform task T₂₁ which was previously not a planned task for member M₁₃. Then, in operation 146 the ad hoc task would be saved to an ad hoc task database. In one embodiment, the ad hoc task database is a flat file. Continuing with the example above, member M₁₃ would enter the request into an ad hoc task database here. Next, in decision operation 148 it is determined whether any more ad hoc tasks have been received. If there are more ad hoc tasks, then the method returns to operation 144 and repeats operations 144, 146 and 148 until all the ad hoc tasks have been received.

Continuing with FIG. 3, once all the ad hoc tasks have been received, the method advances to decision operation 150 where it is determined if there are any completed tasks. If there are completed tasks, then the task data completed for the tracking period is received in operation 152. For example, if the tracking period is one week with Monday the beginning of the tracking period and Friday the end of the tracking period, then completed task data during the tracking period is received here. In one embodiment, the member responsible for the task enters the data in a completed task database. In another embodiment completed task data for ad hoc tasks is received here also. Once all the completed task data is received in operation 152, the method of FIG. 3 is completed. Similarly, if there are no completed tasks in decision operation 150, then the method of FIG. 3 is completed.

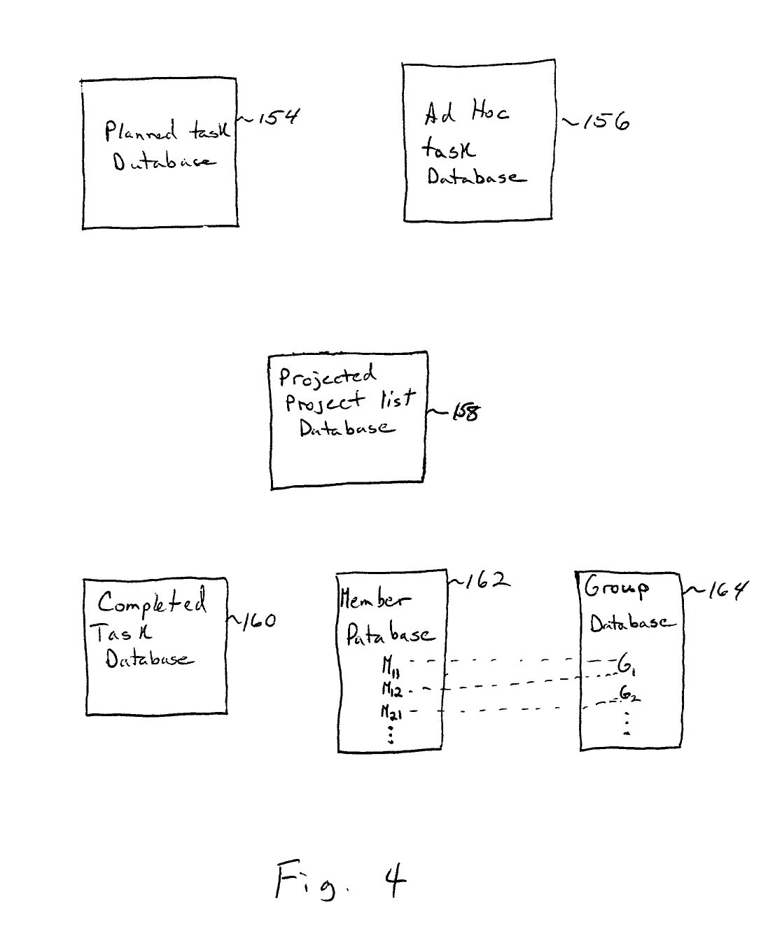

FIG. 4 illustrates a diagram of the various databases used for the personnel resource management tool in accordance with one embodiment of the invention. The projected project list database (PPLD) 158 includes all projected projects as mentioned in operation 102 of FIG. 1. In one embodiment, the PPID 158 is capable of differentiating between approved and non-approved projects. An exemplary printout of a PPLD 158 is contained in TABLE 1 above. The planned task database (PTD) 154 includes all of the planned tasks for each of the approved projects of the PPLD 158 in one embodiment. In one embodiment, each member responsible for completing the task enters the task into the PTD 154, as mentioned with respect to operation 142 of FIG. 3. The ad hoc task database (AHTD) 156 contains all the unscheduled or ad hoc tasks. As mentioned above, when a manager asks a group member to perform a task which was not scheduled or assigned to the member, then the member's planned tasks will be interrupted by this unforeseen task. However, ad hoc tasks which interrupt the members completion of planned tasks are now captured in the AHTD 156 which is easily accessed by the member's manager. In one embodiment, a manager or member can obtain a report of all ad hoc tasks for all the group members. Thus, the manager is provided a more complete picture of the employees work, as well as being provided with the originator of the ad hoc request, which allows a manager to determine if his members are being overextended by one or more other managers. Table 3 provides an exemplary report obtained from an ad hoc database.

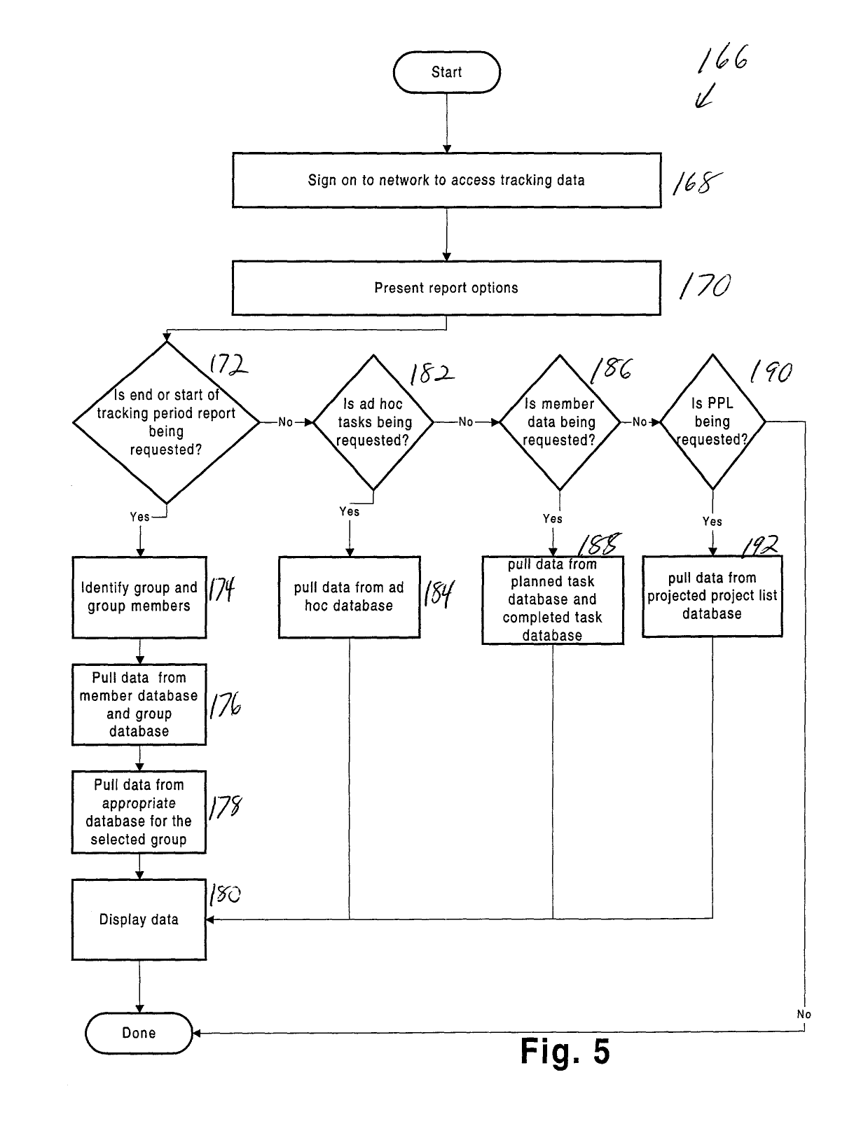

Continuing with FIG. 4, completed task database (CTD) 160 is also included. In one embodiment, the CTD 160 is updated at least once per tracking period. For instance, if the tracking period is weekly as in the example of FIG. 3, then the CTD 160 is updated with the completed task data for the tracking period as discussed in operation 152 of FIG. 3. In one embodiment, a report tracking the planned tasks for a period versus the completed tasks for the period is generated through the combined data of the PID 154 and CTD 160. Table 2 provides an exemplary representation of the planned versus completed tasks. Member database 162 includes the members of the various groups, while group database 164 provides the groups. In one embodiment, the members of the member database 162 are associated with a group of the group database 164. As illustrated in FIG. 4, members M₁₁ and M₁₂ are members of group G₁ and so on. In another embodiment, each group of the group database 164 points to the members in the member database 162 that make up the group. The member database 162 and the group database 164 are discussed further in reference to FIG. 5. In one embodiment, the databases described herein are relational databases. Accordingly, a variety of reports can be created from the data in the databases. In one embodiment, the databases are flat files that have interrelationships among them, such as sharing member names, sharing group names, sharing tasks, sharing priorities, etc.

FIG. 5 illustrates flowchart 166 displaying a method for mining the data in various databases for presentation in accordance with one embodiment of the invention. Flowchart 166 initiates with operation 168 where a user signs on to a network to access tracking data. In one embodiment, the user is capable of accessing the databases from a remote location via the Internet. It should be appreciated, that the present invention, through the use of centralized databases, allows for a web based application that is easily accessible through the Internet. Furthermore, the need for every user to have a copy of proprietary software is also eliminated. In one embodiment, access through a distributed network such as the Internet is controlled through a secure connection requiring passwords. From operation 168 the method advances to operation 170 where report options are presented to a user. The report options can be customized for or by the user in one embodiment. For example, the report options can include tables, charts, spreadsheets, graphs generated from workload, etc.

Flowchart 166 then advances to decision operation 172 where it is determined if the end or start of the tracking period report is being requested. In one embodiment, the end of tracking period report provides the completed task data for the group members, while the start of the tracking period report provides the planned tasks for the group. If the end or start of tracking period reports are being requested then the method advances to operation 174 where the group and group members are identified. It should be appreciated that the group for which the report is requested can be identified during the sign on of operation 168 or the presentation of report options in operation 170. Then, the method proceeds to operation 176 where data is pulled from the member database 162 and the group database 164. In one embodiment, the group database 164 is searched for the group for which the report is being requested. In another embodiment, the groups of the group database 164 include pointers to the members of each group in the member database 162, as mentioned with respect to FIG. 4. Next, the method moves to operation 178 where data is pulled from the appropriate database for the selected group. Where the end of the tracking period report is requested the data is pulled from the completed task database 160. Here, the completed task data entered by each member of the group in operation 152 of FIG. 3 is retrieved. If the start of the tracking period report is being requested, then the data is pulled from the planned task database 154. Then, the method advances to operation 180 where the requested data is displayed. It should be appreciated that the format of the display is capable of being customized by the user. Additionally, the display can be presented as a chart, table, spreadsheet, graphs from workload, results generated from operations, review comments, etc. Accordingly, the manager is able to view the completed tasks for all members of the group as a single report from a centralized location. Similarly, if the start of the tracking period report is being requested, then the manager is able to view the planned tasks for the group as a single report from a centralized location.

If the user is not requesting the end or start of tracking period report in decision operation 172, then the method proceeds to decision operation 182 where it is determined if ad hoc tasks are being requested. If the ad hoc tasks are being requested then, the method advances to operation 184 where the data is pulled from the ad hoc database 156. In one embodiment, the group and group members are identified as described above with respect to operation 174 in order to locate the data for the group in the ad hoc database 156. Once the data has been pulled from the ad hoc database 156, then the data is displayed in operation 180. Alternatively, if the user is not requesting the ad hoc tasks, in decision operation 182, then the method advances to decision operation 186 where it is determined if member data are being requested. If the member data are being requested then, the method advances to operation 188 where the data is pulled from the planned task database 154 and the completed task database 160. In one embodiment, the group and group members are identified as described above with respect to operation 174 in order to locate the data for the planned task database 154 and the completed task database 160. Once the data has been pulled from the planned task database 154 and the completed task database 160, then the data is displayed in operation 180.

Continuing with FIG. 5, if the user is not requesting the member data, in decision operation 186, then the method advances to decision operation 190 where it is determined if the projected project list (PPL) is being requested. If the PPL is being requested then, the method advances to operation 192 where the data is pulled from the PPL database 158. In one embodiment, the group and group members are identified as described above with respect to operation 174 in order to locate the data for the PPL database 158. Once the data has been pulled from the PPL database 158, then the data is displayed in operation 180. If the PPL is not being requested, then the method of FIG. 5 is complete. It should be appreciated that additional databases can be created for additional report options or that additional combinations of the above described databases can create further report options.

It should be appreciated that the can be extended to additional embodiments and provide additional functionality. For example, if a member receives ad hoc tasks which exceed a target limit, then the member or his manager are notified by a warning generated by the system. The warnings can be provided through distributed networks, such as electronic mail. In another embodiment, the reports discussed above can be distributed through electronic mail at defined times to appropriate members of the groups. In yet another embodiment, the system is configured to redirect ad hoc tasks exceeding a target limit for one member to another member. As mentioned above, varying security levels and the ability to delegate authority is provided. In another embodiment, a tool for setting up the system, such as a wizard, is provided for the initial installation or access of the system. Of course, the system described above can be used to forecast delays upon the entry of an ad hoc request. In yet another embodiment, planned tasks that are not completed by a completion date are automatically rolled over until the tasks are completed.

Numerous report types can be generated from the information contained in the databases. For example, statistics are recorded such as the percentage of planned tasks completed by the completion date, the percent of ad hoc tasks completed as compared to the completed planned tasks over a tracking period, the number of initiatives proposed by a member, etc. These statistics can be used to create bar graphs, pie charts, multi-dimensional presentations such as cubes and the like. In another embodiment, information added through a web browser i.e., planned, completed or ad hoc task data as described in reference to Table 1-3, in text is converted to hyper text mark-up language (HTML) as it is entered.

The above described invention may be practiced with other computer system configurations including hand-held devices, microprocessor systems, microprocessor-based or programmable consumer electronics, minicomputers, mainframe computers and the like. The invention may also be practiced in distributing computing environments where tasks are performed by remote processing devices that are linked through a communications network.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data which can be thereafter be read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer systems so that the computer readable code is stored and executed in a distributed fashion.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for tracking task progression for each member in a group, the method comprising:
recording projects of the group;
planning project tasks for each member in the group, the tasks directed towards completing the projects;
receiving a request for an ad hoc task which interrupts a schedule for the planned project tasks;
readjusting the project tasks to capture the interruption of the ad hoc task; and
requesting a report for each member in the group, the report configured to display progress of the project tasks for each member, wherein the report is capable of presenting the ad hoc tasks for each member of the group over a tracking period.

2. The method as recited in claim 1, wherein the recording projects of the group further includes:
approving a set of the projects for implementation.

3. The method as recited in claim 1, further including:
entering completed tasks.

4. The method as recited in claim 1, wherein the projects, the planned tasks, the ad hoc task and the completed tasks are stored in databases as flat files.

5. The method as recited in claim 1, wherein the report is further configured to display a list including planned tasks for the tracking period and completed tasks for the tracking period for each member, the list dynamically readjusting as the project tasks readjust.

6. The method as recited in claim 1, wherein in response to receiving the request for the ad hoc task, the method further includes:
forecasting a delay of a completion date for each of the projects.

7. A computer implemented method for coordinating projects, the projects including tasks to be performed to complete the projects, the method comprising:
establishing a projected project list tallying the projects;
dividing each of the projects of the projected project list into planned tasks;
assigning the planned tasks;
receiving a request for an ad hoc task which interrupts a planned task schedule;
storing the ad hoc task; and
in response to receiving the ad hoc task, the method further includes,
readjusting the planned task schedule to incorporate the interruption caused by the ad hoc task.

8. The method as recited in claim 7, further including:
entering completed tasks; and
presenting reports.

9. The method as recited in claim 7, further including:
updating progress on the planned tasks for each tracking period.

10. The method as recited in claim 9, wherein the tracking period is one week.

11. The method as recited in claim 7, wherein the ad hoc task is a plurality of ad hoc tasks.

12. The method as recited in claim 11, further including:
generating a warning if more than a target limit of the ad hoc tasks are received by a group member.

13. The method as recited in claim 11, further including;
redirecting ad hoc tasks received by a first group member in excess of a target limit to a second group member.

14. A system for monitoring resource utilization of members in a group, the system comprising:
a projected project list database, the projected project list database including initiatives of the group;
a planned task database, the planned task database including planned tasks to be completed over a tracking period for group members;
an ad hoc database, the ad hoc database including non-planned tasks performed by the group members, the non-planned tasks interrupting the planned tasks; and
a completed task database, the completed task database including planned tasks completed over the tracking period, wherein the planned task database and the completed task database is capable of readjusting for schedule slippage due to the non-planned tasks.

15. The system as recited in claim 14 further including:
a report generator, the report generator configured to pull data from the databases to track progress of the planned tasks and list the non-planned tasks for each member of the group.

16. The system as recited in claim 14, wherein the system is accessible through a distributed network.

17. The system as described in claim 15, wherein the report generator is configured to forecast delays to initiatives effected by the readjusting.

18. A computer readable media having program instructions for tracking task progression for each member in a group, comprising:
program instructions for recording projects of the group;
program instructions for planning project tasks for each member in the group, the tasks directed towards completing the projects;
program instructions for receiving a request for an ad hoc task which interrupts a schedule for the planned project task;
program instructions for readjusting the project tasks to capture the interruption of the ad hoc task; and
program instructions for requesting a report for each member in the group, the report configured to display progress of the project tasks for each member, wherein the report is capable of presenting the ad hoc tasks for each member of the group over a tracking period.

19. The computer readable medium as recited in claim 18, wherein the program instructions for recording projects of the group further includes:
program instructions for approving a set of the projects for implementation.

20. The computer readable medium as recited in claim 18, further including:
program instructions for entering completed tasks.

21. The computer readable medium as recited in claim 18, wherein the report is further configured to display a list including planned tasks for the tracking period and completed tasks for the tracking period for each member, the list dynamically readjusting as the project tasks readjust.

22. The computer readable medium as recited in claim 18, wherein the tracking period is one week.
